(19) United States
(12) Patent Application Publication
(10) Pub. No.: US 2007/0286123 A1
(43) Pub. Date: Dec. 13, 2007

(54) System and method for establishing a packet data conection by proxy during a wireless handoff

(75) Inventor: William Joseph Semper, Richardson, TX (US)

Correspondence Address: TIMOTHY F. BLISS, P.O. BOX 793968, DALLAS, TX, 75379, US

(73) Assignee: Samsung Electronics Co., Ltd., Suwon-city (KR)

(21) Appl. No.: 11/451,872

(22) Filed: Jun. 13, 2006

(51) Int. Cl. H04Q 7/20; H04Q 7/00

(52) U.S. Cl. 370/331; 455/436

(57) ABSTRACT

The present disclosure relates generally to systems and methods for a handoff in a wireless network. In one example, a method for handing off a mobile device includes receiving configuration information from the mobile device at a first base station supporting a first communication session between the mobile device and a first packet data node. The configuration information may be forwarded to a second base station for handoff of the mobile device from the first base station to the second base station. A second communication session may be negotiated between the second base station and a second packet data node using the configuration information. Information corresponding to the second communication session may be sent to the mobile device to enable the mobile device to connect to the second packet data node using the second communication session.

### BACKGROUND

Communications networks, such as those that can support wireless voice and/or data, generally support the movement of a mobile device from one area of the network (e.g., a cell) to another. In order to provide such support, a network should support the transfer (e.g., handoff) of the mobile device between areas. One type of commonly used handoff is a hard handoff. In a hard handoff scenario, the connection between the mobile device and the network area that the mobile device is leaving is terminated before the connection between the mobile device and the network area that the mobile device is entering is established. In other words, there is a temporary break in the connection between the mobile station and the network.

Although a hard handoff may not present a problem with certain types of traffic, such as circuit switched voice traffic, such a break in the connection may be detrimental to packet-switched traffic classes such as Voice over Internet Protocol (VoIP) data. Furthermore, the longer the break, the more detrimental it may be to the connection. Accordingly, improvements are needed in handing off a mobile device from one area of a network to another.

### SUMMARY

In one embodiment, a method for handing off a mobile device is provided. The method comprises receiving configuration information from the mobile device at a first base station supporting a first communication session between the mobile device and a first packet data node. The configuration information is forwarded to a second base station for handoff of the mobile device from the first base station to the second base station. A second communication session is negotiated between the second base station and a second packet data node using the configuration information. Information corresponding to the second communication session is sent to the mobile device to enable the mobile device to connect to the second packet data node using the second communication session.

In another embodiment, a method for use by a first base station in a wireless network is provided. The method comprises receiving configuration information from a mobile device, wherein the information represents configuration parameters of a packet data connection existing between the mobile device and a packet data node. The mobile device is identified as needing to be handed off to a second base station, and the configuration information is forwarded to the second base station.

In still another embodiment, a method for use by a first base station in a wireless network is provided. The method comprises receiving configuration information from a second base station, wherein the information represents configuration parameters of a first packet data connection existing between a mobile device currently serviced by the second base station and a first packet data node. A second packet data connection is negotiated with a second packet data node using the configuration parameters, and information corresponding to the second packet data connection is sent to the mobile device.

In yet another embodiment, a system is provided. The system comprises a first base station coupled to a second base station, a first packet data node coupled to the first base station, a second packet data node coupled to the second base station, and a plurality of instructions for execution within the system. The instructions include instructions for receiving configuration information at the first base station from a mobile device, wherein the configuration information includes parameters of a first packet data session between the mobile device and the first packet data node. The instructions also include instructions for negotiating a second packet data session between the second base station and the second packet data node using the configuration information. The instructions also include instructions for sending information corresponding to the second packet data session to the mobile device, wherein the mobile device can use the second packet data session without having to negotiate the second packet data session with the second packet data node.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a flowchart illustrating one embodiment of a method for performing a handoff in a wireless network.

FIG. 2 is a diagram of one embodiment of a wireless network within which the method of FIG. 1 may be implemented.

FIG. 3 is a flowchart illustrating one embodiment of a method that may be used within the network of FIG. 2 to receive configuration information from a mobile device and forward the configuration information within the network.

FIG. 4 is a flowchart illustrating one embodiment of a method that may be used within the network of FIG. 2 to negotiate a network connection on behalf of a mobile device.

FIG. 5 is a diagram illustrating one embodiment of a message sequence that may be used for executing a handoff within the system of FIG. 2.

### DETAILED DESCRIPTION

It is to be understood that the following disclosure provides many different embodiments, or examples, for implementing different features of the disclosure. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

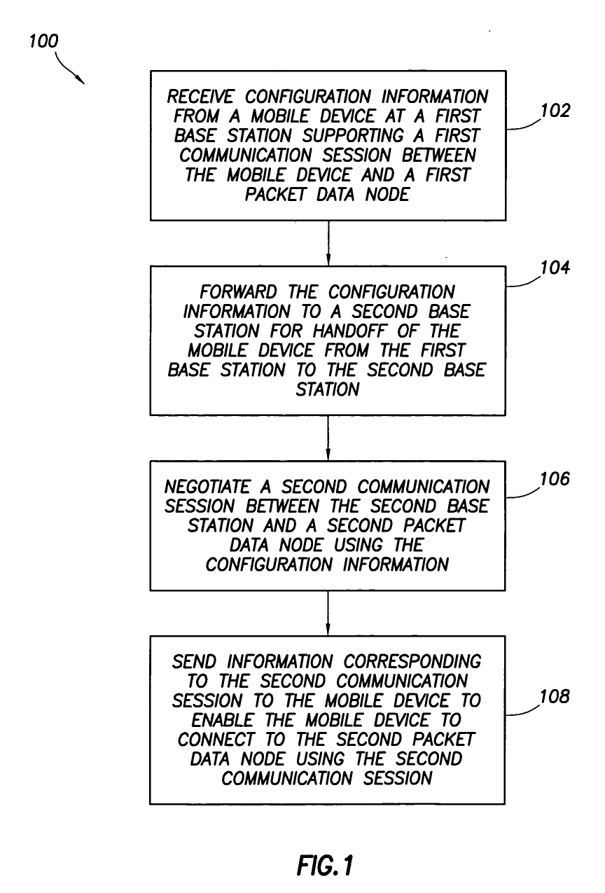

Referring to FIG. 1, in one embodiment, a method 100 may be used to optimize the establishment of a communication session during a handoff procedure. In the present example, a mobile device is being handed off from one cell in a communication network to another cell. The mobile device is engaged in a packet data communication session using protocols such as a mobile internet protocol (MIP) and a point-to-point protocol (PPP) over a network connection provided by the communications network. The network connection provided by the communication network may include multiple connections, such as an air traffic channel between the mobile device and a base station, and a transport channel between the base station and a packet-switched node (e.g., a packet data node such as a Packet Data Serving Node (PDSN)) connecting the mobile device to a packet network such as the Internet.

In a traditional communication network, such as wireless access networks based on Code Division Multiple Access 2000 (CDMA2000) technology, a base station may initiate a hard handoff of an active packet data call to another base station. The base station that receives the call after the handoff (referred to as the Target BS or BS-T) may be connected to a PDSN other than the one to which the originating BS (called the Source BS or BS-S) is connected. Normally, this results in re-negotiations for protocols such as PPP and MIP (if being used by the mobile device) when the mobile device has successfully been handed off. However, this re-negotiation between the mobile device and the PDSN may be disruptive to packet data traffic and may degrade a sensitive application such as VoIP.

To accomplish the handoff without such re-negotiations, the communication network may pass a pair of IP addresses for the originating PDSN (PDSN-S) to the BS-T via handoff messages. The BS-T may then attempt to contact the PDSN-S directly using one of the IP addresses or, if this is not possible, may send the second IP address to the PDSN-T. The PDSN-T may then attempt to establish a PPP connection to the PDSN-S over an IP network connecting both PDSNs. It is noted that two IP addresses may be passed because the IP network may be different than the network connecting each base station to its respective PDSN. If the PDSN-T is connected to the PDSN-S by the same IP network, the PDSN-T may establish a PPP connection with the PDSN-S and tunnel any traffic to or from the mobile device to the PDSN-S over this tunnel. This may eliminate the need to re-negotiate PPP and MIP when the mobile device is handed off to the BS-T and PDSN-T, although the PDSN-T should be able to contact the PDSN-S for such tunneling to occur. However, if the PDSN-T cannot contact the PDSN-S, then the mobile device will need to renegotiate the connection with the PDSN-T.

The method 100 may be used to optimize the negotiation of a packet data session for use between the mobile device and the PDSN-T. In step 102, the base station currently coupled to the mobile device via the air traffic channel (e.g., the BS-S) receives configuration information from the mobile device. As will be described later in greater detail, the configuration information may include various parameters corresponding to the session between the mobile device and the PDSN-S. In step 104, the BS-S forwards the configuration information to another base station (e.g., the BS-T) for handoff of the mobile device.

In step 106, the BS-T receiving the mobile device during handoff may negotiate a communication session with the PDSN-T using the configuration information. In step 108, after negotiating the new communication session with the PDSN-T, the BS-T sends information corresponding to the new session to the mobile device. This enables the mobile device to connect to the PDSN-T using the second communication session without having to negotiate the new session itself. Accordingly, the BS-T may act as a proxy for the mobile device during negotiations with the PDSN-T and optimize the handoff process.

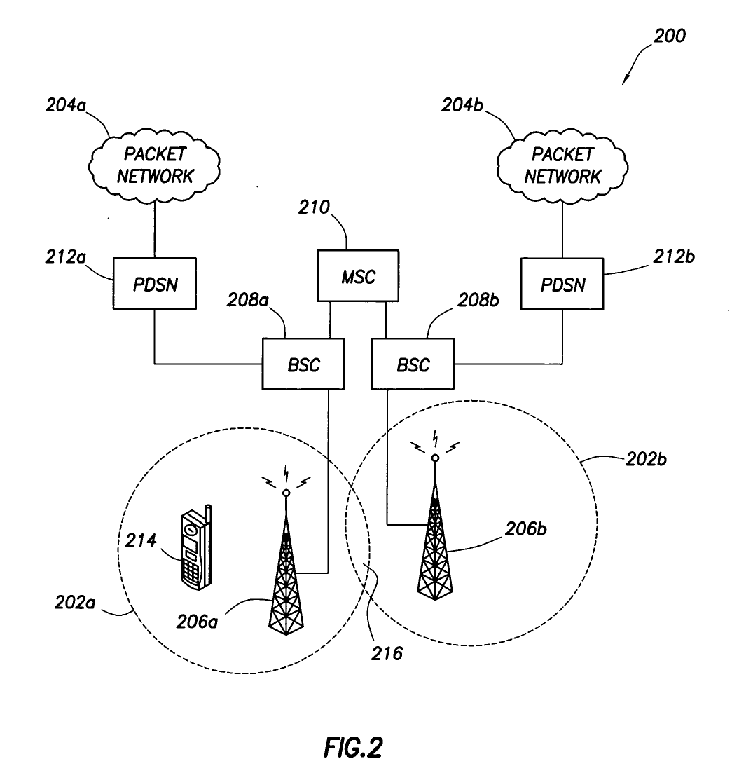

Referring to FIG. 2, a communications network 200 illustrates one embodiment of a system within which the method 100 of FIG. 1 may be used. In the present example, the network 200 is a CDMA network that may be compatible with a variety of standards including, but not limited to, Interim Standard 95 (IS-95), Interim Standard 2000 (IS-2000) and Universal Mobile Telecommunications System (UMTS). The network 200 may represent other technologies, including Global System for Mobile communication (GSM), and Orthogonal Frequency Division Multiplexing (OFDM). Accordingly, it is understood that the methods of the present disclosure may be performed in networks based on different technologies, such as High Rate Packet Data-based Radio Access Networks (HRPD-based RANs) and that the examples using a CDMA network are for purposes of illustration only.

The network 200 comprises a plurality of cells 202a, 202b. In the present example, the network 200 is a wireless network, and may be connected to other wireless and/or wireline networks, such as packet networks 204a, 204b. Each cell 202a, 202b in the network 200 includes a base station (BS) 206a, 206b, respectively, that are coupled to base station controllers (BSC) 208a, 208b, respectively. A mobile switching center (MSC) 210 may be used to connect the network 200 with other networks such as a Public Switched Telephone Network (PSTN) (not shown). Although not shown, the base stations 206a and 206b may be coupled to the same BSC, and the BSCs 208a and 208b may be coupled to separate MSCs.

The BSCs 208a, 208b are also coupled to packet-switched nodes (e.g., packet data nodes such as PDSNs) 212a, 212b, respectively, each of which is coupled to one of the packet networks 204a, 204b. The terms “packet” and “packet data”, as used in the present disclosure, may be interchangeable and may include any type of encapsulated data, including datagrams, frames, packets, and the like, and the encapsulated information may include voice, video, data, and/or other encapsulated information. The packet networks 204a, 204b may be the same network or separate networks, and may be any combination of private and public networks based on any packet technology, such as the Internet Protocol (IP) and the Transport Control Protocol (TCP).

The network 200 enables a mobile device 214 to communicate with another device (not shown) via the BTS 206a associated with the cell 202a in which the mobile device is located. Although illustrated in FIG. 2 as a cellular phone, it is understood that the mobile device 214 may be any portable device capable of wirelessly participating in a packet session, and such devices may include personal digital assistants, portable computers, pagers, and/or cellular phones. The cells 202a, 202b overlap so that the mobile device 214 may travel from one cell to another (e.g., from the cell 202a to the cell 202b) while maintaining a communication session. In a handoff region 216 (e.g., the area where the cells 202a, 202b overlap), the mobile device 214 may be serviced by both the BTS 206a and the BTS 206b.

Referring to FIG. 3, in one embodiment, a method 300 may be executed within a system, such as the system 200 of FIG. 2, to aid in handing off a mobile device's packet data session from one cell to another cell. In the present example, the method 300 may be executed within a base station (e.g., the base station 206a), but it is understood that at least portions of the method may be executed elsewhere, such as in the BSC 208a, and that various steps of the method may be performed by different network elements. Furthermore, messages may actually be sent and received via network elements (e.g., the BSCs 208a, 208b, and MSC 210) that have been omitted from the present embodiment for purposes of illustration.

In the present example, the method 300 begins after a connection between the base station 206a and the mobile device 214 has been established, and the mobile device has established a packet data session with the PDSN 212a using MIP and PPP. In step 302, the base station 206a receives configuration information (e.g., parameters) from the mobile device 214. Examples of such configuration parameters for MIP and PPP may include indicators for simultaneous bindings, broadcast datagrams, decapsulation by mobile node, minimal encapsulation, generic routing encapsulation (GRE), and/or use of Van Jacobson header compression. The mobile station 214 may also send the home address, care-of address, and home agent IP address being used by the mobile device, as well as an identifier such as a 64-bit identification number being used by the mobile device. Examples of configuration parameters that may be sent by the mobile device 214 to the base station 206a for PPP include an identifier for the mobile device, as well as options that may be used during the PPP negotiations with the PDSN. Such options may include Maximum-Receive-Unit, Authentication-Protocol, Quality-Protocol, Protocol-Field-Compression, and/or Address-and-Control-Field-Compression.

In step 304, the base station 206a may determine that the mobile device 214 needs to be handed off to another base station, such as the base station 206b. This determination may be made by the base station 206a or may be made elsewhere and communicated to the base station.

In step 306, in addition to handoff related messaging, the base station 206a may send various configuration parameters to the base station 206b. In the present example, the parameters may be sent with the handoff messages (e.g., inserted into a field of a handoff message or otherwise encapsulated therewith) or may be sent separately.

Examples of such configuration parameters for MIP may include indicators for simultaneous bindings, broadcast datagrams, decapsulation by mobile node, minimal encapsulation, generic routing encapsulation (GRE), and/or use of Van Jacobson header compression. The base station 206a may also send the home address, care-of address, and home agent IP address being used by the mobile device 214, as well as an identifier such as a 64-bit identification number being used by the mobile device.

Examples of configuration parameters that may be sent by the base station 206a to the base station 206b for PPP include an identifier for the mobile device 214, as well as options that may be used by the base station 206b during the PPP negotiations with the PDSN 212b. Such options may include Maximum-Receive-Unit, Authentication-Protocol, Quality-Protocol, Protocol-Field-Compression, and/or Address-and-Control-Field-Compression.

It is understood that the parameters provided are for purposes of illustration and are not intended to be limiting. Accordingly, other parameters may be used and such parameters may vary depending on such factors as the particular protocol or protocols being used, as well as the configuration of the network within which the parameters are implemented. Furthermore, if such parameters are not supported by the network 200 or a particular portion of the network (e.g., the base station 206b), then the parameters may be ignored. For example, if the base station 206a does not support the parameters received from the mobile device 214, the base station may ignore them and process the call normally. If the base station 206a supports the parameters but the base station 206b does not, the base station 206b may receive the parameters and ignore them. Alternatively, the base station 206a may not send the parameters to the base station 206b if the base station 206b does not support them. Accordingly, the transfer of the parameters between the elements of a network (or between different networks) may be implemented in different ways.

In step 308, the base station 206a may instruct the mobile device 214 to switch to the base station 206b. It is understood that messages commonly used during a handoff process may be exchanged during the method 300, but is not shown for purposes of clarity.

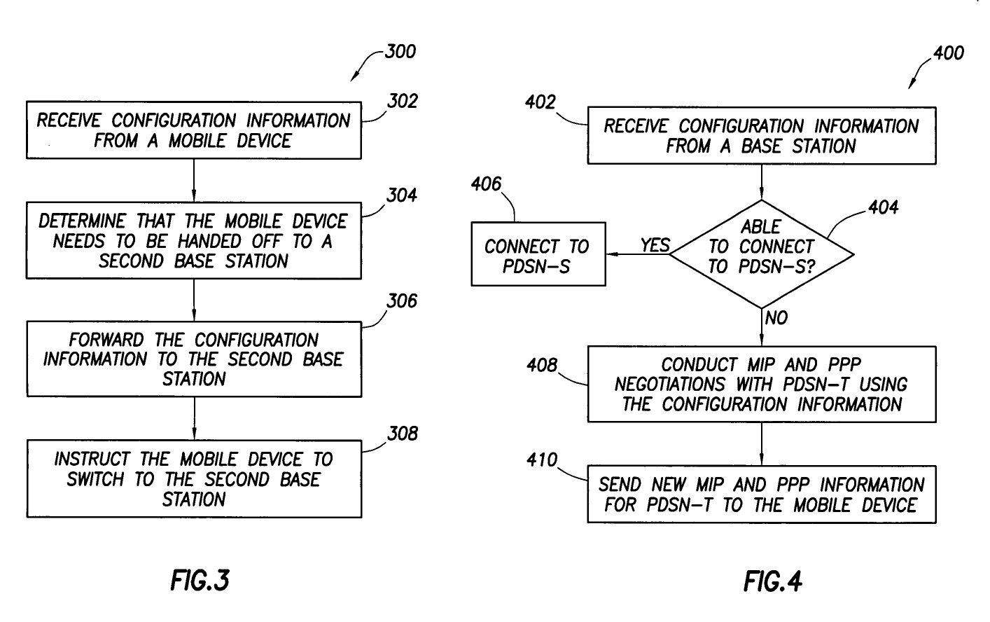

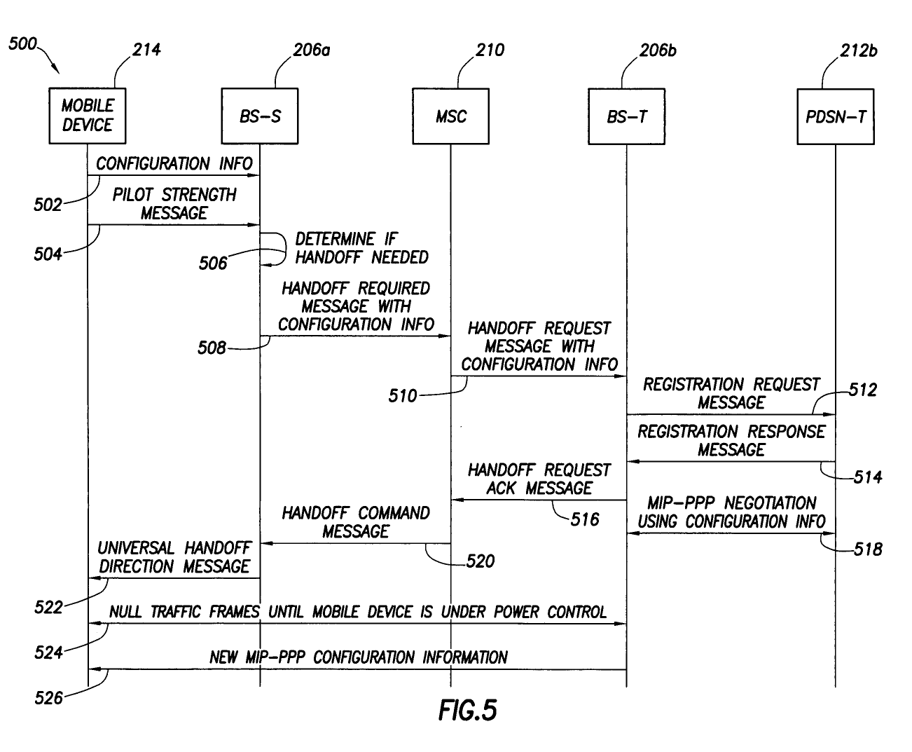

Referring to FIG. 4, in another embodiment, a method 400 may be executed within a system, such as the system 200 of FIG. 2, to aid in handing off a mobile device's packet data session (based on MIP and PPP) from one cell to another cell. In the present example, the method 300 may be executed within a base station (e.g., the base station 206b), but it is understood that the method may be executed elsewhere, such as in the BSC 208b.

In step 402, the base station 206b receives configuration information from the base station 206a. As discussed with respect to FIG. 3, this information may include various identifiers and parameters corresponding to the mobile device 214 and a packet data communication session with which the mobile device is involved. In step 404, the base station 206b may attempt to connect to the PDSN 212a. If the connection attempt is successful, the base station 206b may support the established session between the PDSN 212a and the mobile device 214 in step 406. If the base station 206b cannot connect to the PDSN 212a, the base station may enter into negotiations with the PDSN 212b in step 408 to establish a new session using the configuration parameters received in step 402. For example, if the session between the mobile device 214 and PDSN 212a uses MIP and PPP, the base station 206b may conduct MIP and PPP negotiations with the PDSN 212b. Accordingly, the base station 206b may act as a proxy for the mobile device 214 and negotiate the connection before the mobile device may do so itself

In step 410, once the negotiation is complete and the connection is established, the base station 206b may send the new MIP and PPP information to the mobile device 214. The mobile device 214 may then connect to the new PDSN 212b without having to negotiate the connection with the PDSN 212b. It is understood that messages commonly used during a handoff process may be exchanged during the method 400, but is not shown for purposes of clarity.

Referring to FIG. 5, one embodiment of a message sequence 500 that may be used to hand off a mobile device is provided. For purposes of example, the mobile device is the mobile device 214 of FIG. 2, the BS-S is the base station 206a of FIG. 2, the BS-T is the base station 206b of FIG. 2, the MSC is the MSC 210 of FIG. 2, and the PDSN-T is the PDSN 212b of FIG. 2.

In step 502, the mobile device 214 sends configuration information to the BS-S 206a. As described previously, the configuration information may represent various identifiers and parameters associated with the mobile device 214 and a packet data session between the mobile device and the PDSN-S 212a (FIG. 2). In step 504, the mobile device 214 may send a message such as a pilot strength measurement message to the BS-S 206a. Based on the pilot strength measurement message, the BS-S 206a may determine in step 506 whether a handoff is needed. Steps 504 and 506 may repeat until the call ends (if no handoff is needed) or until the BS-S 206a determines that a handoff is needed. Once the need for a handoff is determined, the BS-S 206a sends a message such as a Handoff Required message and the configuration information (either within or separate from the Handoff Required message) to the MSC 210. It is understood that if the base stations 206a and 206b are not connected to the same MSC, inter-MSC communication may be needed. One example of such inter-MSC communication is described in the IS-41 standard, which is hereby incorporated by reference in its entirety.

In step 510, the MSC 210 may send the configuration information to the BS-T 206b with a message such as a Handoff Request message. As with the Handoff Required message, the configuration information may be sent with the Handoff Request message (e.g., encapsulated therein) or may be sent separately. In the present example, although a step for contacting the PSDN-S 212a is not illustrated, such a step may occur in the sequence 500. For example, step 404 of FIG. 4 may be implemented between steps 510 and 512. In step 512, the BS-T 206b sends a message such as a Registration Request message to the PDSN-T 212b. In step 514, the PDSN-T 212b sends a message such as a Registration Response message to the BS-T 206b and the BS-T may then send a message such as a Handoff Request Ack message to the MSC 210 to acknowledge the handoff request in step 516.

In step 518, the BS-T 206b may act as a proxy for the mobile device 214 and conduct negotiations (e.g., MIP and PPP negotiations) with the PDSN-T 212b to establish a connection. It is understood that the negotiations of step 518 may begin before the message of step 516 and may not end until after step 524.

In steps 520 and 522, the handoff process may continue as the MSC 210 sends a message such as a Handoff Command message to the BS-S 206a and the BS-S sends a message such as a Universal Handoff Direction message to the mobile device 214 instructing the mobile device to switch to the BS-T 206b. In step 524, the mobile device 214 and the BS-T 206b may exchange null traffic frames until the mobile device is under power control of the BS-T.

In step 526, the BS-T 206b may send the configuration information to the mobile device 214 for the new connection established by the BS-T acting as proxy for the mobile device. In the present example, such information may include MIP and PPP parameters. The mobile device 214 may then connect to the PDSN-T 212b after receiving the information in step 526 without having to negotiate the packet data connection with the PDSN-T itself. Accordingly, the handoff process may be optimized by enabling a connection with the PDSN-T 212b to be established while handoff is occurring, rather than waiting for the mobile device 214 to be handed off to the BS-T 206a before beginning negotiations for the connection.

It is understood that various messages, such as those between the MSC 210, the base stations 206a and 206b, the PDSNs 212a and 212b, and other network elements (such as the BSCs 208a and 208b) may be performed in accordance with one or more specified standards, such as TIA-2001, which is hereby incorporated by reference. As stated previously, inter-MSC communication may be performed as described in previously incorporated IS-41. It is understood that the message sequence 500 and the particular messages described are only one example of many possible sequences and that the functionality provided by the sequence 500 may be achieved using different sequences and/or messages.

Although only a few exemplary embodiments of this disclosure have been described in details above, those skilled in the art will readily appreciate that many modifications are possible in the exemplary embodiments without materially departing from the novel teachings and advantages of this disclosure. Also, features illustrated and discussed above with respect to some embodiments can be combined with features illustrated and discussed above with respect to other embodiments. For example, various steps from different flow charts may be combined, performed in an order different from the order shown, or further separated into additional steps. Furthermore, steps may be performed by network elements other than those disclosed. Accordingly, all such modifications are intended to be included within the scope of this disclosure.

What is claimed is:

1. A method for handing off a mobile device comprising:
receiving configuration information from the mobile device at a first base station supporting a first communication session between the mobile device and a first packet data node;
forwarding the configuration information to a second base station for handoff of the mobile device from the first base station to the second base station;
negotiating a second communication session between the second base station and a second packet data node using the configuration information; and
sending information corresponding to the second communication session to the mobile device to enable the mobile device to connect to the second packet data node using the second communication session.

2. The method of claim 1 further comprising instructing the mobile device to switch from the first base station to the second base station before sending information corresponding to the second communication session to the mobile device.

3. The method of claim 2 wherein the negotiating the second communication session and the instructing the mobile device to switch from the first base station to the second base station occur substantially simultaneously.

4. The method of claim 1 further comprising determining that the mobile device needs to be handed off to the second base station before forwarding the configuration information to the second base station.

5. The method of claim 1 further comprising attempting, by the second base station, to contact the first packet data node, wherein negotiating the second communication session with the second packet data node only occurs if the second base station cannot contact the first packet data node.

6. The method of claim 1 wherein negotiating the second communication session includes negotiating at least one of a mobile internet protocol (MIP) connection and a point to point protocol (PPP) connection.

7. A method for use by a first base station in a wireless network comprising:
receiving configuration information from a mobile device, wherein the information represents configuration parameters of a packet data connection existing between the mobile device and a packet data node;
identifying that the mobile device needs to be handed off to a second base station; and
forwarding the configuration information to the second base station.

8. The method of claim 7 further comprising instructing the mobile device to switch to the second base station.

9. The method of claim 7 wherein identifying that the mobile device needs to be handed off to the second base station includes making a determination that the handoff is needed based on a pilot strength measurement message.

10. The method of claim 7 wherein the configuration information is forwarded to the second base station via a mobile switching center.

11. A method for use by a first base station in a wireless network comprising:
receiving configuration information from a second base station, wherein the information represents configuration parameters of a first packet data connection existing between a mobile device currently serviced by the second base station and a first packet data node;
negotiating a second packet data connection with a second packet data node using the configuration parameters; and
sending information corresponding to the second packet data connection to the mobile device.

12. The method of claim 11 wherein the information corresponding to the second packet data connection is sent to the mobile device after the mobile device is handed off to the first base station.

13. The method of claim 11 further comprising:
receiving a handoff request from the second base station; and
acknowledging the handoff request.

14. The method of claim 13 wherein the negotiating the second packet data connection occurs substantially simultaneously with acknowledging the handoff request.

15. The method of claim 11 further comprising attempting to contact the first packet data node prior to negotiating the second packet data connection, wherein the second packet data connection is not negotiated if the first packet data node is successfully contacted.

16. A system comprising:
a first base station coupled to a second base station;
a first packet data node coupled to the first base station;
a second packet data node coupled to the second base station; and
a plurality of instructions for execution within the system including instructions for:
receiving configuration information at the first base station from a mobile device, wherein the configuration information includes parameters of a first packet data session between the mobile device and the first packet data node;
negotiating a second packet data session between the second base station and the second packet data node using the configuration information; and
sending information corresponding to the second packet data session to the mobile device, wherein the mobile device can use the second packet data session without having to negotiate the second packet data session with the second packet data node.

17. The system of claim 16 further comprising instructions for forwarding the configuration information from the first base station to the second base station after determining that the mobile device needs to be handed off to the second base station.

18. The system of claim 17 wherein the configuration information is included in a handoff request sent from the first base station to the second base station.

19. The system of claim 16 further comprising instructions for attempting to contact the first packet data node by the second base station prior to negotiating the second packet data session, wherein the second packet data session is not negotiated if the first packet data node is successfully contacted.

20. The system of claim 16 further comprising a mobile device configured to send the configuration information to the first base station.
